(19) United States
(12) Patent Application Publication
(10) Pub. No.: US 2013/0152194 A1
(43) Pub. Date: Jun. 13, 2013

(54) SYSTEM, METHOD AND SOFTWARE FOR CONTROLLING ACCESS TO VIRTUAL MACHINE CONSOLES

(71) Applicants: Nir Barak, Karmi Yosef (IL); Itzhak Fadida, Haifa (IL); Amir Jerbi, Givatayim (IL)

(72) Inventors: Nir Barak, Karmi Yosef (IL); Itzhak Fadida, Haifa (IL); Amir Jerbi, Givatayim (IL)

(73) Assignee: COMPUTER ASSOCIATES THINK, INC., Islandia, NY (US)

(21) Appl. No.: 13/313,130

(22) Filed: Dec. 7, 2011

(51) Int. Cl. G06F 21/00

(52) U.S. Cl. 726/21; 726/2

(57) ABSTRACT

A system and method for controlling access to virtual machine consoles. The system includes a console access controller configured to register an owner to a virtual machine to open a defined limit of consoles and capture the defined limit of consoles. An image console control is configured to receive a request to check-out one or more of the captured consoles in one of an exclusive mode and a shared mode and determine whether the check-out request was made by the owner. The console access controller is further configured to open the one or more captured consoles in the exclusive mode to the owner if the check-out request is made by the owner and recapturing the one ore more consoles in response to a check-in request from the owner.

### FIELD OF THE INVENTION

This invention relates generally to the field of virtual machines and more particularly to a system, method and software for controlling access to virtual machine consoles.

### BACKGROUND OF THE INVENTION

Cloud computing and virtual machines (VM) are used by enterprises to access software applications and perform a wide variety of computing functions. Management and security issues are important concerns in the virtual machine environment. One such important security issue is the control of VM consoles. The existing prior art in this domain control access to VM consoles through permissions in the virtualization environment applications.

The problem with exiting solutions is that virtualization environment administrators are usually not the VM owners; therefore, they can get access to VM consoles they do not own. VM owners do not control who accesses their VM consoles. When a customer receives a VM in the cloud, the VM console can be accessed by the virtualized environment administrators, potentially exposing the data for access from the virtualized environment management system. Further, while using the VM console, someone may view everything they do on the console. For example, when the current VM owner uses the console, someone may open it, view the console and potentially may even alter data currently put in. Consider a scenario where a customer asks for a VM, receives that VM, but has no exclusive control on the VM console. Therefore, when the VM owner works on the console others can see what the owner is doing. Moreover, someone with access to the virtualization environment can directly open and work on the VM console. In addition, if the current VM owner forgets to log out, there is no need for a password to get console access.

One prior art system for console access works by changing the network flow to force the user to go through their system by putting components between servers and clients. This system is quite intrusive, as well as error prone. If someone does have another way to get to the system, this protection will not work. The system is still controlled by the virtualization environment administrators.

Another prior art console access system is built on static permissions that are given inside the virtualization management systems, so the virtualization environment manager can give console access to anyone else. Those options still allow the administrator to give himself or others access to the console when he wants, with or without the VM owner's knowledge.

There is a need in this field for a solution for virtual environments that will put the control on the VM console back into the current VM owners and not allow virtualization environment administrators to view or use a VM console without permissions from the VM owner. Thus, achieving higher trust between cloud customers and cloud administrators.

### SUMMARY OF THE INVENTION

The present invention solves the problem of console control by ensuring that only the current VM owner can access the console for the VMs that he owns. Administrators will not be able to open the VM console, even if the virtualized environment permissions allow them to access the VM console. Users with privileges to open the console will not be able to open the console while the current VM owner uses it, unless explicitly allowed to by the VM owner.

A system that restricts the number of open VM consoles and takes control on all the available consoles is disclosed. A console will be freed only by specific request from the VM owner. Therefore, even if the virtualized environment permissions permit another user to open a console, this user will not be able to open a console to the VM. Once a current VM owner begins using the VM, the user can make sure his work on the console is not exposed and others do not get access to the console of his VM.

The system of the present invention provides current VM access control systems with additional enforcement capabilities for controlling access to VM consoles, including ensuring that VM owner controls the console, and not the virtualized environment administrators or an arbitrary user with a virtual environment privilege to open the console. No one else is able to view the console when the current VM owner uses it (not even a user that is permitted by the virtualized environment to open the VM console) unless the VM owner explicitly grants access to additional users.

The invention captures the VM consoles of the protected image while releasing VM consoles only by a specific request authorized by the current VM owner. Administrators on the virtualized environment cannot use VM consoles to get access to VMs they did not get authorization from the current VM owner. A current VM owner can share the console with others if needed, but this is done in a controlled manner, only for the specific period. When a current VM owner stops using his console, it is put back into locked mode so others cannot use it.

In one embodiment, the present invention is directed to a system and method for controlling access to virtual machine consoles. The system includes a console access controller configured to register an owner to a virtual machine to open a defined limit of consoles and capture the defined limit of consoles. An image console control is configured to receive a request to check-out one or more of the captured consoles in one of an exclusive mode and a shared mode and determine whether the check-out request was made by the owner. The console access controller is further configured to open the one or more captured consoles in the exclusive mode to the owner if the check-out request is made by the owner and recapturing the one ore more consoles in response to a check-in request from the owner.

### BRIEF DESCRIPTION OF THE DRAWINGS

These and other features, benefits, and advantages of the present invention will become apparent by reference to the following figures, with like reference numbers referring to like structures across the views, wherein:

FIG. 1 is a block diagram of the system of the invention.

FIG. 2 is a flow diagram of the process of one embodiment the invention.

FIG. 3 is a flow diagram of the process of another embodiment of the invention.

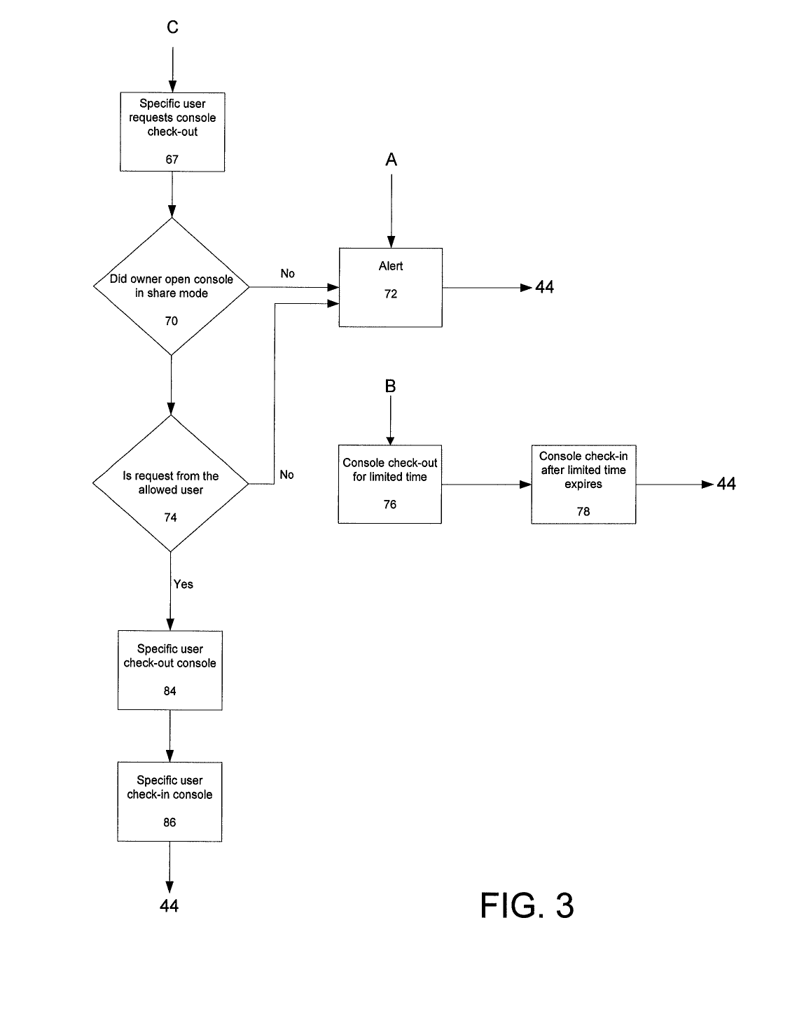

### DETAILED DESCRIPTION OF THE INVENTION

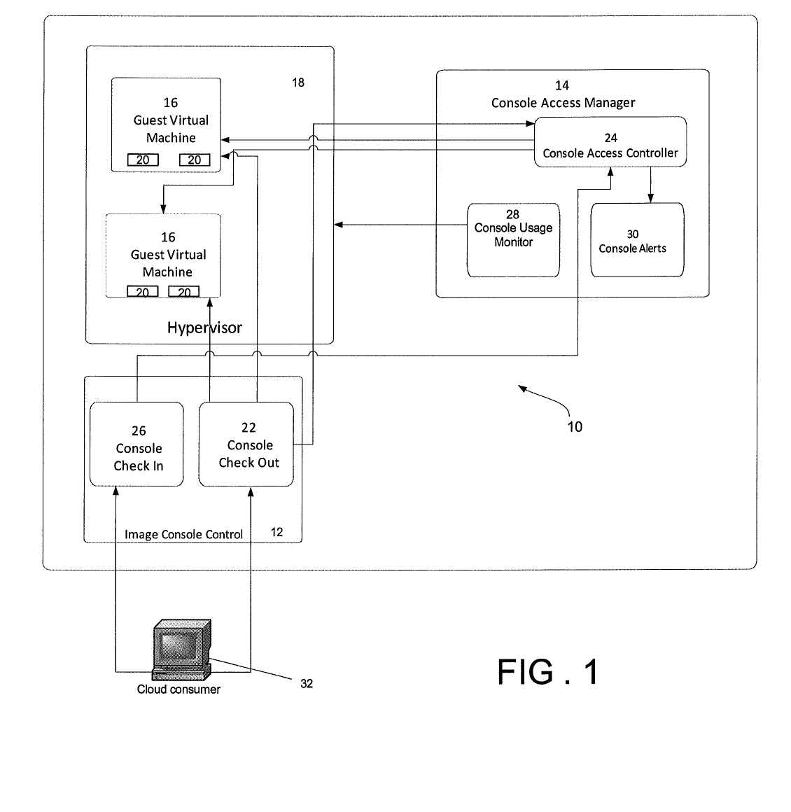

FIG. 1 is a block diagram of one embodiment of the system of the present invention. The system 10 of the invention includes an image console control 12 and a console access manager 14. The system 10 controls access to consoles for guest virtual machines 16, managed by hypervisor 18. A plurality of consoles 20 can be opened for use of the VM 16 by a customer or owner 32. Two consoles are depicted for each VM but any number can be opened as permitted by the owner.

Image console control 12 is used to request access to VM consoles 20. Access is only granted if the VM owner has allowed this user access to his VM console. In one embodiment, by default, access is allowed only to the current VM owner himself. The console access controller 14 then releases one of the captured consoles and will let the console check out 22 open the console.

When a console 20 is ready to be released by the current VM owner, or permitted users, console access controller 24 recaptures the console so that other users are not able to obtain it without the permission from console access manager 14 or originally the current VM owner.

The console access controller 24 component captures the consoles of the protected VMs 16. The console access controller 24 will release a protected VM console 20 by request of a console check out component 22 from the current owner of the VM only or any other user working on his behalf that was authorized by the current VM owner. The console access controller 24 will capture the VM again when notified by the console check in component 26 or console monitor 28.

Console monitor 28 monitors VMs in the environment by scanning VM consoles in case the console was released without a regulated check in process. The console monitor 28 notifies the console access controller 24 of VM consoles that are not captured by either the console access controller 24 or the current VM owner himself, so the console access controller 24 can capture them to prevent access to the consoles except for the VM current owner or some other user he has allowed access to the VM console on his behalf.

The console monitor 28 also detects if an unauthorized user was able to access a VM console. For example, if the monitor finds sessions opened to a console that according to the console access controller (24) is not currently checked out (or the session holder is not authorized to access the console), the monitor determines that the user is unauthorized. In this case the console monitor 28 terminates those sessions in order for the console access controller 24 to capture the console instead and put it back under control.

If anyone besides the current VM owner attempts to or succeeds in getting access to a VM console, it will be detected by the monitor (28) and then the alert component will take care of actions according to the recovery policy for the VM. The console alert control 30 will generate an alert and activate a process to regain control of the VM console. This is done by terminating sessions of users that were able to get unauthorized console access.

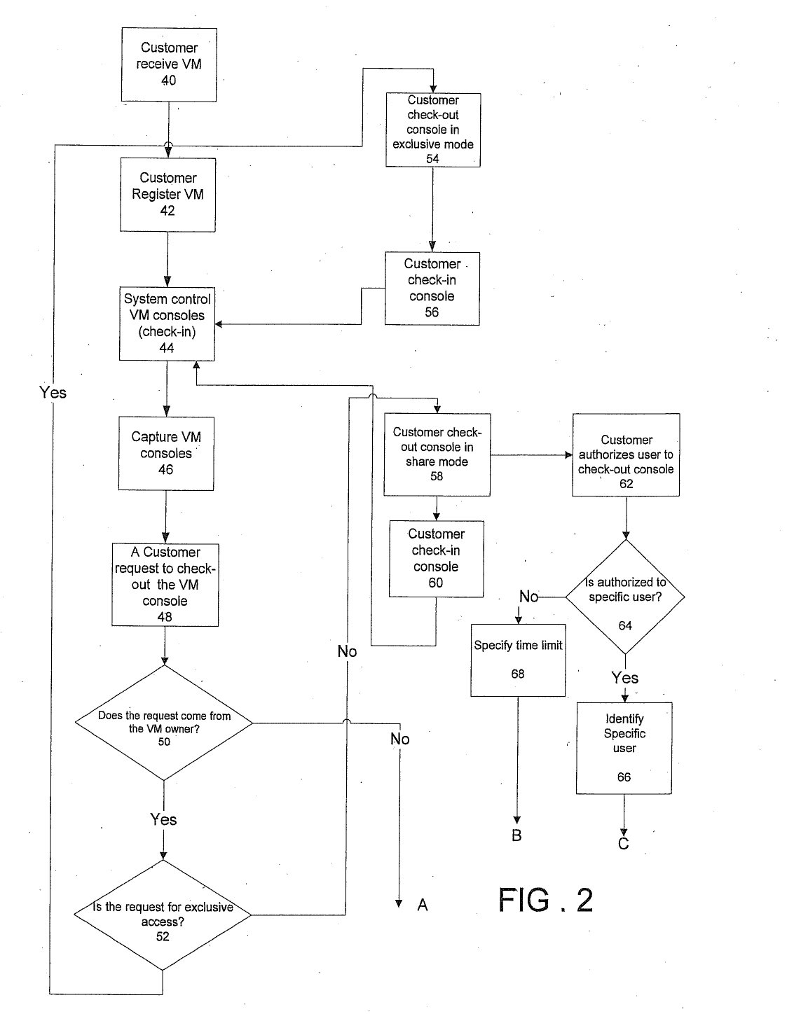

Referring now to FIG. 2, a process of activation and access control of VM consoles is described.

In step 40, a customer receives a VM from the cloud provider. Before placing sensitive data on the VM, the VM owner registers with the console access controller 24 in step 42 so the system knows who the current VM owner is. Console access controller 24 marks the current VM owner of the image. In step 44, the system now verifies the VM console limit is set to a number it can control and in step 46 captures the entire number of available consoles allowed. Typically two or three consoles will be the limit, but any number according to circumstances may be controlled. Now other users cannot open a console on the protected VM, since all available consoles are being held by the console access controller 24.

To open a console on the VM in step 48 the current VM owner needs to request the system to release a console on the VM. The console checkout request can be done in exclusive or shared mode. The exclusive mode can be set as a default mode. When the console is no longer needed for immediate use, it is checked back in, so the system can control it again.

In step 50, the system determines whether the request comes from the VM owner. If yes, then in step 52 the system determines whether the request is for exclusive access. If yes, then in step 54 the customer checks-out and uses the console in the exclusive mode. Then when the customer finishes using VM console, in step 56, the customer checks-in the console. The system then returns to step 44, where the system controls the VM consoles.

In step 50, if the request does not come from the VM owner, then in step 72 an alert is generated for unauthorized console access. Then the system regains control of the VM consoles in step 44.

In step 52, if the request is not for exclusive access then in step 58, the customer checks-out and uses console in a shared mode. In step 62 the customer authorizes other users to check-out a console. The customer has the option of authorizing a specific user or providing non-specific authorization. If a specific user is authorized, YES in step 64, the specific user is identified in step 66. In order for the specific user to gain access to the console, a request must be made to check-out a console in step 67. Before allowing check-out, the system first determines whether the owner opened the console in the shared mode in step 70. If NO, an alert is provided in step 72. If the owner did open the console in a shared mode, YES in step 70, the system determines whether the request was from the specific user in step 74. If NO, the alert is provided in step 72. If YES, the specific user then checks-out the console in step 84. Then the specific user, based on customer approval, can view and use the console.

If a non-specific authorization is given, No in step 64, authorization is given for only a limited time in step 68. The console is then check-out for the limited time in step 76 and checked-in after the limited tome expires in step 78.

The owner can then check out one or more additional consoles up to the limit defined when the owner registered. Then the customer and others check in the console when they are finished in step 60 for the owner or 78/86 for another user in the shared mode. If the owner does the check in, this terminates and checks in all console sessions including all others if opened. Once checked in, the system regains control of the VM consoles in step 44. When the customer is finished using the console in the shared mode, the console check-in step 60 is used to return the console to the control of the controller in step 44.

In one embodiment of the system, a customer requests access to a VM image from cloud provider and the cloud provider sets up the image. The customer register as the owner of the VM image and the console access manager registers the VM and the user and captures all the available VM consoles. The customer now needs access to the VM console. The customer uses the console check out to get a console on his VM; he can now safely use the VM console since only one VM console was freed so others cannot get concurrent VM console access. The customer checks the console back in when finished using the console. The console access controller captures the console again and no one else can now get access to the VM console.

In another embodiment, the system provides an alert if a VM console access attempt is made by an unauthorized user. A customer requests access to a VM image from cloud provider. The cloud provider sets up the image. The customer registers as the current owner of the VM image. The console access manager registers the VM and the user and captures all the available VM consoles. A user with privileges to the virtualized environment attempts to open a console to this VM. The attempt fails as there is no console available to be opened (all are being held by the console access controller). The current VM owner now checks out the VM console and starts using it. A user with privileges to the virtualized environment wants to view what the current VM owner is currently typing on the VM console. The user tries to open another VM console to the same VM again. The attempt fails, because the console access controller has released only one VM console that is already in use by the current VM owner. An alert is generated in order for the current VM owner to be notified about this attempt.

In a further embodiment, non-exclusive access to VM consoles is provided. A customer requests access to a VM image from the cloud provider. The cloud provider sets up the image. The customer registers as the current owner of the VM image. The console access manager registers the VM, sets up the owner and captures all the available VM consoles. The current VM owner checks out the VM console and starts using it. At some point he wants to share the console with someone so the other person is able to view the current screens on his VM console (for example trying to get support on a problem on the VM). The current VM owner then uses the console check out to specify that one more console should be released and the user that can catch it. The authorized user now uses the console check out and the console access controller frees up another console for him as the VM owner allowed it.

Both users check the console back in, once done. VM consoles released are now re-captured by the Console Access Controller, so they are kept protected.

The system and method of the present invention provides several advantages. VM console access is tied to a current VM owner, and not virtualized environment administrators or other users with virtualized environment privileges to the VM console. Automatically locking and unlocking VM consoles based on the current VM owner console use is also provided. A current VM owner always know which users are currently using the VM console, if any are permitted. The system allows exclusive and non exclusive VM console use, based on the current VM owner decision and current needs. A user will gain access to the protected console, only if he really needs it, and in a controlled manner. The invention can be incorporated with new and existing virtual environments with minimal requirements.

The system of the present invention works on top of the current infrastructure and current network set up. There is no need to put components in between the servers and clients, and to change the network setup and routing.

In the present system, the permissions to use VM consoles from the virtualization environment controls are separate, thereby segregating the control of the consoles by simply capturing all the available ones, and then free them on authorized requests, not based on static permissions setup, but based on requests from the VM owners themselves, and only they decide how their console can be accessed.

Furthermore, for many customers, the option to share consoles and have someone be able to see what is done by someone else that has access to the console is a security issue, but sometimes it is needed. Therefore, the VM owner should be the one to control access. When the owner requests access, each time he specifies if he takes it exclusive (no one else can share it) or shared, and also who can share it if he wants to restrict this further. The system provides the opportunity to specify how to check out the consoles (exclusive or shared), and then you check it back in when use is finished. No one regardless of the virtualization environment permissions can access the consoles until the owner allows it.

The VM owner will show the data on his VM console, only if he needs it, and in a controlled way. In addition, automatic locking and unlocking of VM console is provided in a further embodiment. The administrator is granted access for limited period based on approval from VM owner. After elapsed time, VM console is taken from administrator. This invention allows integration with new and existing virtual environments. Because it can work independently from the virtual environment by exercising common functionalities of these environments, making integration possible with minimal requirements from the virtual environment.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The computer readable medium is a computer readable storage device, which may be, for example, a magnetic, optical, electronic, electromagnetic, infrared, or semiconductor system, apparatus, or device, or any suitable combination of the foregoing; however, the computer readable storage device is not limited to these examples. Additional particular examples of the computer readable storage device can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage device is also not limited to these examples. Any tangible medium that can contain, or store a program for use by or in connection with an instruction execution system, apparatus, or device could be a computer readable storage device.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method for controlling access to virtual machine consoles, comprising the steps of
registering an owner to a virtual machine to open a defined limit of consoles;
capturing the defined limit of consoles;
receiving a request to check-out one or more of the captured consoles in one of an exclusive mode and a shared mode;
determining whether the check-out request was made by the owner;
opening the one or more captured consoles in the exclusive mode to the owner if the check-out request is made by the owner; and
recapturing the one or more consoles in response to a check-in request from the owner.

2. The method of claim 1 further including the step of providing an alert if the check-out request is not made by the owner.

3. The method of claim 1 further including the steps of opening a first console in a shared mode to the owner and receiving a request from the owner to authorize console check-out by others.

4. The method of claim 3 further including the step of determining whether the authorization request is for a specific user.

5. The method of claim 4 wherein if the authorization request is for a specific user, receiving a request to check-out an additional console from the specific user and opening the additional console to the specific user.

6. The method of claim 4 wherein if the authorization request is not for a specific user, opening an additional console for a limited time in response to a check-out request.

7. The method of claim 6 wherein the console is checked-in after the limited time expires.

8. The method of claim 5 further comprising the step of recapturing all opened consoles in response to a console check-in request by the owner.

9. The method of claim 1 further comprising the steps of monitoring the virtual machine for un-captured consoles not checked out and recapturing the un-captured consoles.

10. The method of claim 3 further comprising the steps of detecting use of a console by an unauthorized user, terminating the unauthorized use of the console and recapturing the console.

11. The method of claim 3 further comprising the steps of detecting an attempt to access a console by an unauthorized user and providing an alert in response to the attempt.

12. A system for controlling access to virtual machine consoles comprising:
a console alert control configured to register an owner to a virtual machine to open a defined limit of consoles, and capture the defined limit of consoles,
an image console control configured to receive a request to check-out one or more of the captured consoles in one of an exclusive mode and a shared mode and determine whether the check-out request was made by the owner;
the console access controller being further configured to open the one or more captured consoles in the exclusive mode to the owner if the check-out request is made by the owner, and recapturing the one ore more consoles in response to a check-in request from the owner.

13. The system of claim 12 further comprising a console usage monitor configured to monitor the virtual machine for un-captured consoles not checked out and recapturing un-captured consoles.

14. The system of claim 13 wherein the console usage monitor is configured to detect use of a console by an unauthorized user, terminate the unauthorized use of the console and recapture the console.

15. The system of claim 14 wherein the console usage monitor detects an attempt to access a console by an unauthorized user.

16. The system of claim 15 further comprising a console alert control configured to alert the owner of the unauthorized use of a console.

17. The system of claim 12 wherein the console access controller is configured to provide an alert if the check-out request is not made by the owner.

18. The system of claim 12 wherein the console access controller is configured to open a first console in a shared mode to the owner and receive a request from the owner to authorize console check-out by others.

19. The system of claim 18 wherein the console access controller is configured to determine whether the authorization request is for a specific user.

20. The system of claim 19 wherein the console access controller is configured to, if the authorization request is for a specific user, receive a request to check-out an additional console from the specific user and open the additional console to the specific user.

21. The system of claim 19 wherein the console access controller is configured to, if the authorization request is not for a specific user, open an additional console for a limited time in response to a check-out request.

22. The system of claim 21 wherein the console access controller is configured to check-in the console after the limited time expires.

23. The system of claim 20 wherein the console access controller is configured to recapture all opened consoles in response to a console check-in request by the owner.

24. A computer readable storage device having a computer readable program for operating a computer, the program comprising instructions that causes the computer to perform the steps of:
registering an owner to a virtual machine to open a defined limit of consoles;
capturing the defined limit of consoles;
receiving a request to check-out one or more of the captured consoles in one of an exclusive mode and a shared mode;
determining whether the check-out request was made by the owner;
opening the one or more captured consoles in the exclusive mode to the owner if the check-out request is made by the owner; and
recapturing the one or more consoles in response to a check-in request from the owner.

25. The storage device of claim 24 wherein the instructions further cause the computer to perform the step of monitoring the virtual machine for un-captured consoles not in use by the owner or authorized user and recapturing un-captured consoles.

26. The storage device of claim 25 wherein the instructions further cause the computer to perform the steps of detecting use of a console by an unauthorized user, terminating the unauthorized use of the console and recapturing the console.

27. The storage device of claim 26 wherein the instructions further cause the computer to perform the step of alerting the owner of the unauthorized use of a console.

28. The storage device of claim 27 wherein the instructions further cause the computer to perform the steps of detecting an attempt to access a console by an unauthorized user and alerting the owner of the attempt.

29. The method of claim 24 wherein the instructions further cause the computer to perform the step of providing an alert if the check-out request is not made by the owner.

30. The method of claim 24 wherein the instructions further cause the computer to perform the steps of opening a first console in a shared mode to the owner and receiving a request from the owner to authorize console check-out by others.

31. The method of claim 30 wherein the instructions further cause the computer to perform the step of determining whether the authorization request is for a specific user.

32. The method of claim 31 wherein the instructions further cause the computer to perform, if the authorization request is for a specific user, the step of receiving a request to check-out an additional console from the specific user and opening the additional console to the specific user.

33. The method of claim 31 wherein the instructions further cause the computer to perform, if the authorization request is not for a specific user, the step of opening an additional console for a limited time in response to a check-out request.

34. The method of claim 33 wherein the instructions further cause the computer to perform, the step of the checking-in the console after the limited time expires.

35. The method of claim 32 wherein the instructions further cause the computer to perform the step of recapturing all opened consoles in response to a console check-in request by the owner.
